(19) United States
(12) Patent Application Publication
(10) Pub. No.: US 2021/0289006 A1
(43) Pub. Date: Sep. 16, 2021

(54) Modifications to Electronic Communication Protocols to Facilitate Agent-based Communications

(71) Applicant: SecondBody, Inc., New York, NY (US)

(72) Inventor: Arlo Hill, New York, NY (US)

(73) Assignee: SecondBody, Inc., New York, NY (US)

(21) Appl. No.: 17/195,926

(22) Filed: Mar. 9, 2021

Related U.S. Application Data
(60) Provisional application No. 62/987,547, filed on Mar. 10, 2020.

(51) Int. Cl. H04L 29/06; H04L 12/931

(52) U.S. Cl. CPC H04L 65/105; H04L 49/70; H04L 65/1069; H04L 65/1003; H04L 65/102

(57) ABSTRACT

A communication application is implemented in which the application implements transmission routing protocols and other parameters for subjects to utilize remote agents during a virtual communication session. The communication session may be hosted by a remote host service that each participant, including the subjects and agents, access using extensibility from a proprietary communication application, plugin, or a web browser application. One of the user-participants may create the communication session, which, in typical implementations, would have four participants—two subjects and two agents. Initiating an active state may trigger a set of communication protocols and parameters, whether standardized or user-customized. The communication routing protocols prohibit communication between the two subjects, including restricting A/V (Audio/Video) and text transmissions. This way, the agents are the conduits through which the subjects communicate with each other.

### CROSS-REFERENCES TO RELATED APPLICATIONS

This Non-Provisional Utility Patent Application claims the benefit of and priority to U.S. Provisional Patent Application Ser. No. 62/987,547, filed Mar. 10, 2020, entitled “Methods and Systems to Communicate,” the entire contents of which is hereby incorporated herein by reference.

### BACKGROUND

Interpersonal physical and virtual communications are often affected by preconceived notions—whether experientially—or prejudicially-based—about the other party. Put simply: how we see someone changes how we hear them. Most virtual communication platforms provide a myriad of uniform features by which participants can communicate that do not focus on enhancing the interaction's collaborative and interpersonal nature and fruitfulness.

### SUMMARY

A communication application is implemented in which the application implements transmission routing protocols and other parameters for subjects to utilize remote agents during a virtual communication session. A remote host service may host the communication session that each participant, including the subjects and agents, access using extensibility from a proprietary communication application, plugin, or a web browser application (e.g., Safari®, Firefox®, or Chrome®).

One of the user-participants may create the communication session, which, in typical implementations, would have four participants—two subjects and two agents. For clarity in exposition, the participants are referred to herein as Subject A, Subject B, Agent A, and Agent B. Upon creation, the session may enter an inactive state during which the host service monitors for the participants to join the session. Communications may be prohibited between the subjects during the inactive state. The host service may transition the session into an active state upon detecting that each participant, typically the two agents and two subjects, have entered the session.

Initiating the active state may trigger a set of communication protocols and parameters, whether standardized or user-customized. In typical implementations, the communication protocols prohibit any communications between Subject A and Subject B, including A/V (Audio/Video) and text transmissions. Subject A can have unrestricted A/V communications to and from Agent B, and Subject A can transmit outbound audio communications to Agent A. Likewise, Subject B can have unrestricted A/V communications to and from Agent A, and Subject B can transmit outbound audio communications to Agent B. The agents join the communication session using two distinct computing devices to receive the distinct communications from the subjects, or the locally-instantiated application can identify and disperse communications to distinct speakers or earbuds from a single device. The session may prevent any communications between the agents.

The communication application's configuration to permit outbound audio communications to a single agent enables that agent to act as a conduit through which communications travel to the other subject. The unrestricted A/V transmissions between a subject-agent pair create the semblance that the agent is the principal in the conversation instead of merely the other subject's proxy.

The technological implementation of communication protocols and parameters within the communication session facilitates the capability to use agents as conduits through which communications are passed between subjects. The regulation of A/V communications within the session can be performed remotely at the host service or locally on the respective participants' computing devices. Furthermore, the locally-instantiated communication application is configured with a user interface (UI) that propounds the semblance that agents are the actual principal actors to which the respective subjects communicate while simultaneously reducing the agent's appearance as, in fact, a detached and neutral proxy. The technological ecosystem of features leverages software and hardware controls to make agent-based interactions not only possible, but believable.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative representation of two subjects virtually communicating;

FIG. 2 shows an illustrative representation of a subject communicating with an agent for another subject;

FIG. 3 shows an illustrative representation in which communications are blocked between the two subjects;

FIG. 4 shows an illustrative representation in which two agents act as communication proxies for the subjects;

FIG. 5 shows an illustrative layered architecture for a computing device;

FIG. 6 shows an illustrative diagram of a communication schema;

FIG. 7 shows an illustrative diagram of routing protocols for the communication schema;

FIG. 8 shows an illustrative representation of user's accessing a communication session;

FIG. 9 shows an illustrative user interface (UI) for a subject;

FIG. 10 shows an illustrative UI for an agent;

FIG. 11 shows an illustrative UI for the subject after the agent joins the session;

FIG. 12 shows an illustrative UI for the agent after the subject joins the session;

FIG. 13 shows an illustrative overview of the routing protocols for a typical communication session;

FIG. 14 shows an illustrative representation of the agent's second device scanning a QR (Quick Response) presented on their primary computing device;

FIGS. 15 and 16 show illustrative diagrams of the communication session's routing protocols;

FIG. 17 shows an illustrative schema of automated rules at the start-up of a communication session;

FIG. 18 shows an illustrative diagram of the different states for a communication session;

FIG. 19 shows an illustrative UI for an administrator within a session;

FIG. 20 shows the illustrative administrator's UI with exposed options;

FIGS. 21-24 show illustrative processes implemented by one or more computing devices, such as a remote service, smartphone, laptop, or personal computer, for executing the present modifications to electronic communication protocols to facilitate agent-based communications;

FIG. 25 shows a simplified block diagram of a computing device that may be used to implement the present modifications to electronic communication protocols to facilitate second body communications; and

FIG. 26 shows a simplified block diagram of a computing device that may be used to implement the present modifications to electronic communication protocols to facilitate second body communications.

Like reference numerals indicate like elements in the drawings. Elements are not drawn to scale unless otherwise indicated.

### DETAILED DESCRIPTION

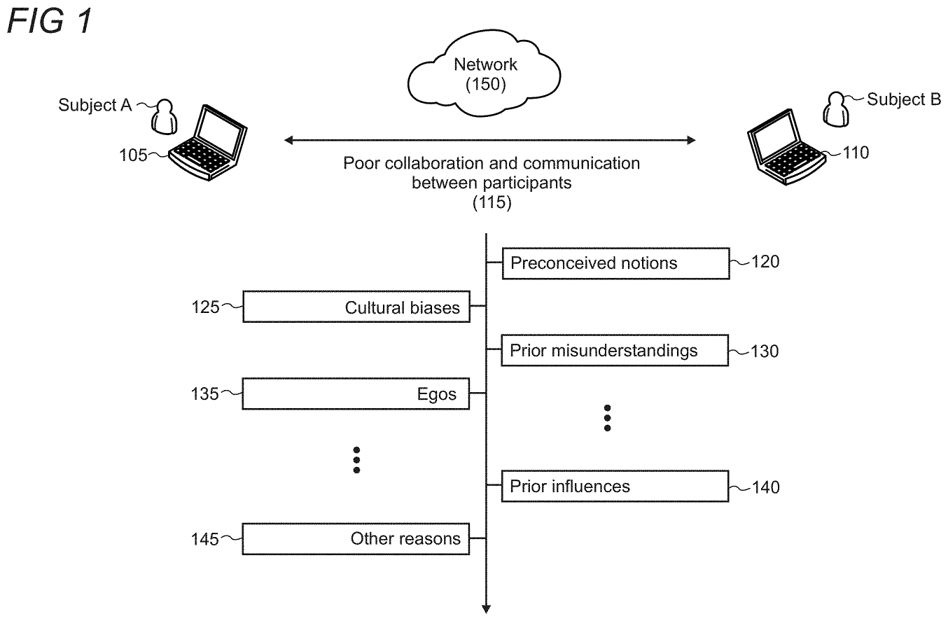

FIG. 1 shows an illustrative representation in which two exemplary subjects, Subject A and Subject B, remotely communicate using respective computing devices 105, 110 over network 150. The network may include any one or more of a personal area network (e.g., Bluetooth®, WiFi, or NFC (Near Field Communication) technology), local area network (LAN), wide area network (WAN), the Internet, or the World Wide Web. In some scenarios, the collaboration and communications between the subjects can be poor, as representatively shown by numeral 115. The poor interpersonal communications may stem from various bases between the parties, including preconceived notions 120, cultural biases 125, prior misunderstandings 130, egos 135, prior influences 140, and other reasons 145. At times, conversing with neutral strangers can subdue the bases that influence a subject's actions, beliefs, and comments.

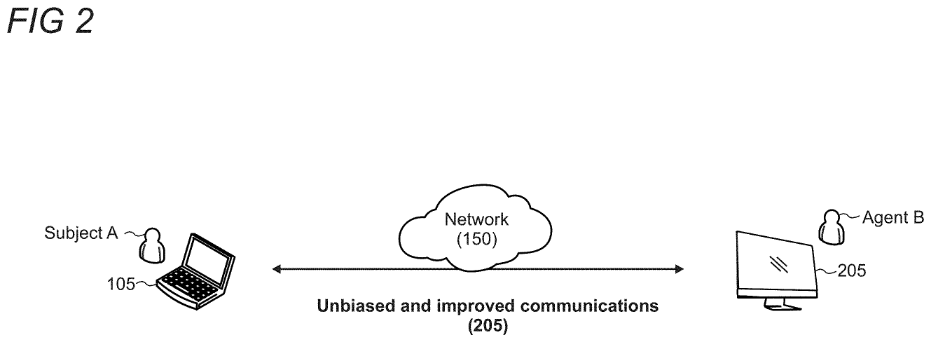

FIG. 2 shows an illustrative representation in which Subject A communicates with Agent A over network 150. Whether through A/V (Audio/Video) channels, solely audio, or solely text, the communications can result in unbiased and improved communications between the two participants, as illustratively represented by numeral 205. The replacement of the known Subject B (FIG. 1) with unknown Agent B can help resolve some of the bases that commonly and negatively influence the discussions between them.

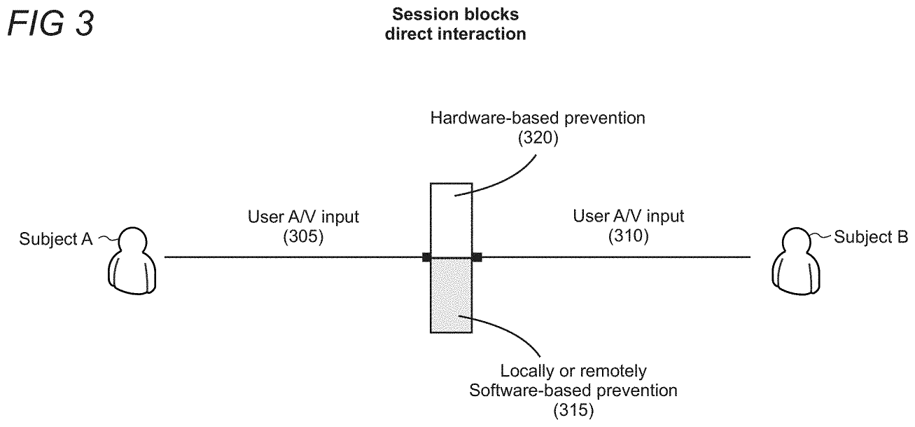

FIG. 3 shows an illustrative representation in which user A/V inputs 305, 310 are blocked during a virtual communication session. The communications between the subjects may be prevented by the user's hardware setup or by locally or remotely executing software techniques, as representatively shown by numerals 320 and 315. The software prevention techniques may be performed by routing protocols inside communication sessions, as discussed in greater detail below, or may be prevented at the hardware level (e.g., obscuring an input at a headset configured to receive communications from a particular participant).

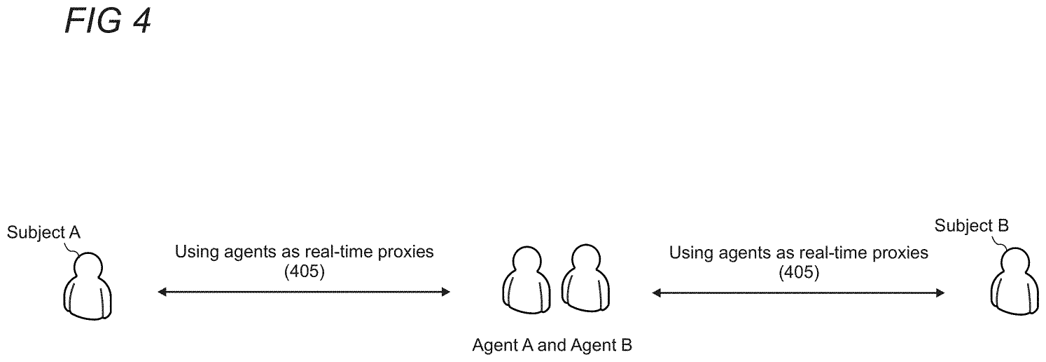

FIG. 4 shows an illustrative and simplistic structural diagram of how communications are routed during a typical virtual communication session. Specifically, Subjects A and B utilize Agents A and B to serve as real-time proxies for communications between the subjects, as representatively shown by numeral 405. Subjects A and B may, in typical implementations, never directly exchange communications with each other during an active state of the communication session, but rather, will directly interact with the agents according to routing protocols.

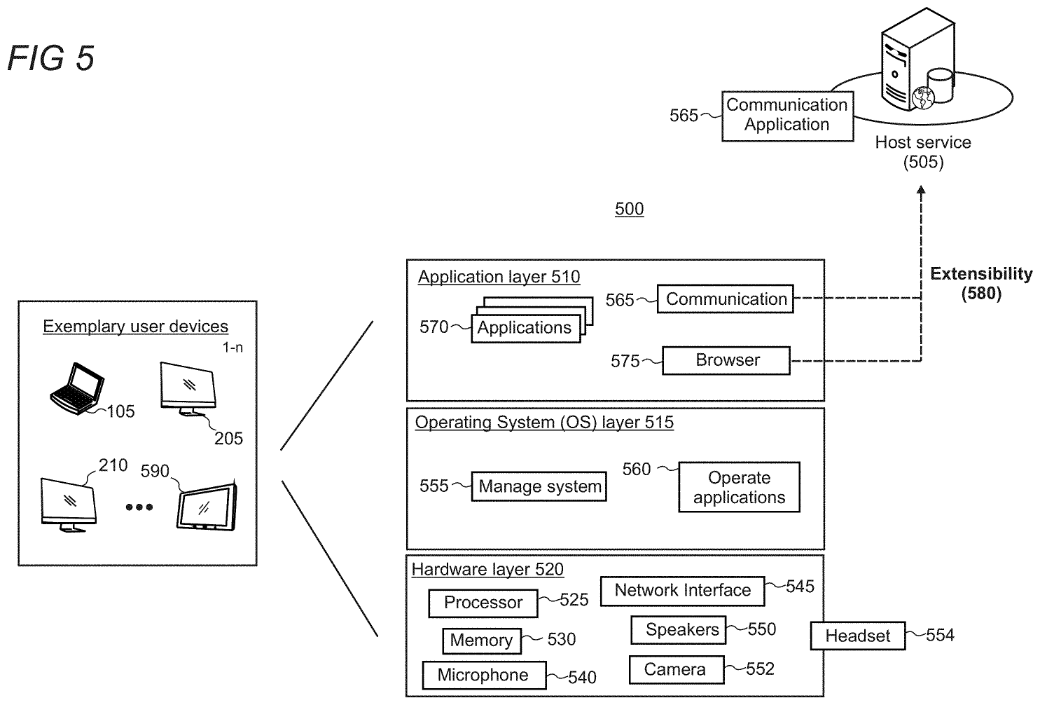

FIG. 5 shows an illustrative layered architecture 500 of exemplary user devices 105, 110, 205, 210, 590, which may be used to implement the communication system described herein. The architecture may apply to, for example, computing devices operated by subjects, agents, spectators, or, in some examples, an administrator that monitors the session.

The computing devices can include a hardware layer 520, operating system (OS) layer 515, and application layer 510. The hardware layer 515 provides an abstraction of the various hardware used by the computing device (e.g., input and output devices, networking and radio hardware, etc.) to the layers above it. In this illustrative example, the hardware layer supports processor(s) 525, memory 530, input/output devices including a microphone 540, speakers 550, camera 552 (e.g., webcam), and headset 554, among other peripheral devices not shown. The computing device may likewise include a network interface 545, such as a network interface card (NIC) that enables wired (e.g., Ethernet) or wireless communications to a router or other computing device. For example, one or more network interface devices may enable the transmission of WiFi signals to a router and be configured with Bluetooth® or NFC (Near Field Communication) capabilities.

The application layer 510 in this illustrative example supports various applications 570, a communication application 565 that facilitates the creation of virtual communication sessions and the exchange of communications between participants, and a web browser application 575 that can access a remotely-instantiated communication application. The locally-instantiated communication application and browser have extensibility 580 to and interoperate with the remote communication application hosted on a remote host service 505. Features implemented by the communication application discussed herein may be performed by the local computing device, the remote host service, or a combination of both. For example, while typically the host service may host a communication session among participants operating respective devices, a local instance of the session may be controlled by a computing device in some implementations. The specific operations may depend on a given implementation and use-scenario. Although the distinct applications or a browser are depicted in FIG. 5, the communication application may alternatively operate as a plugin to another virtual communication platform (e.g., Zoom®, Skype®, Teams®) or the OS. Furthermore, any discussion regarding a locally-executing communication application 565 may alternatively reflect utilizing a plugin or the web browser application that accesses a uniform resource locator (URL) at which the remote communication application runs.

Although only certain applications are depicted in FIG. 5, any number of applications can be utilized by the computing devices. The applications are often implemented using locally executing code. However, in some cases, these applications can rely on services and/or remote code execution provided by remote servers or other computing platforms such as those supported by a service provider or other cloud-based resources.

The OS layer 515 supports, among other operations, managing system 555 and operating applications/programs 560. The OS layer may interoperate with the application and hardware layers in order to perform various functions and features.

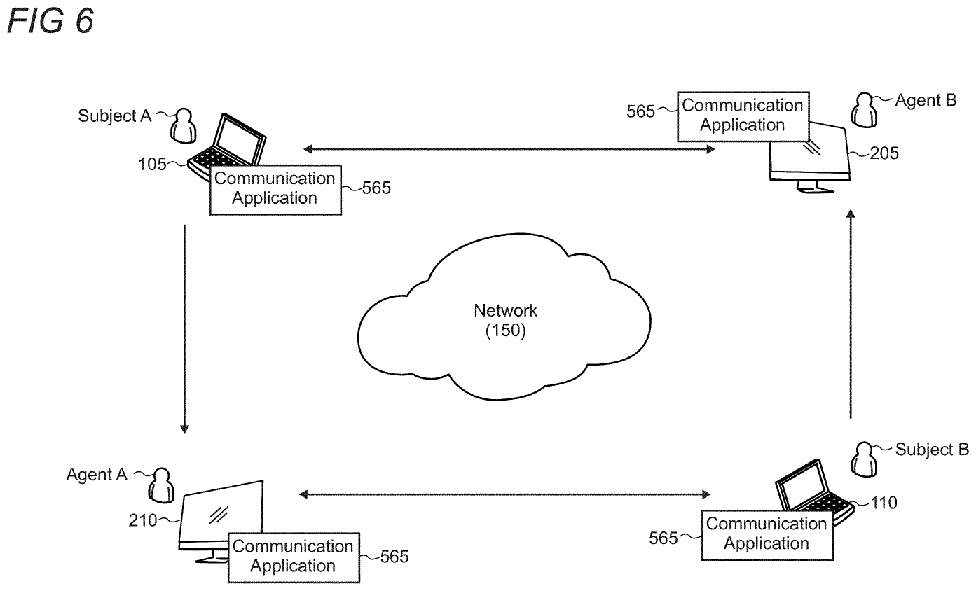

FIG. 6 shows an illustrative diagram of a communication schema among the participants, including Subjects A and B and Agents A and B. Each participant utilizes the locally executing communication application 565 to communicate with each other. In typical implementations, Subject A communicates with Agents A and B and, likewise, Subject B communicates with Agents A and B. Agent A has no direct line of communication with Agent B, and Subject A has no direct line of communication with Subject B. Generally, FIG. 6 presents the communication schema provided by the communication application.

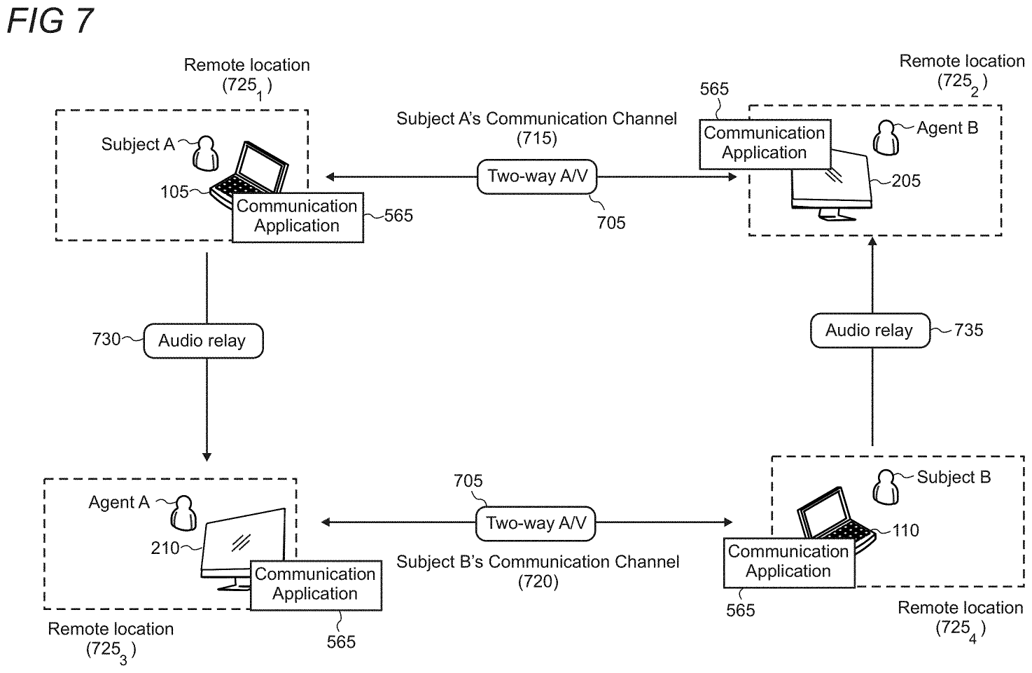

FIG. 7 shows an illustrative diagram of the communication schema with additional technical details implemented in a typical communication session. Each participant may be located remote from other participants, as representatively illustrated by numerals 725. In some implementations, however, two or more participants (e.g., a subject and agent with two-way A/V) may be locally proximate to each other, such as within the same building or room. In this scenario, certain routing protocols and the communication application may still operate to effectuate the nearby circumstances.

Subject A's primary communication channel is with Agent B, and Subject B's primary communication channel is with Agent A, as representatively shown by numerals 715 and 720. These primary communication channels permit two-way A/V (Audio/Video) 705 communications between the subjects and agents to facilitate and enrich the semblance that the agent is the principal in the conversation—and not a proxy. Further to this end, one-way audio relays 730, 735 are provided from Subject A to Agent A and Subject B to Agent B.

The audio relays 730, 735 are received at the respective agents and then spoken by the respective agents to the other subject. Thus, Subject A's comments, which are intently directed to Agent B, are audio-relayed to Agent A, and Agent A mirrors those comments to Subject B. Any response from Subject B is, while also intently directed to Agent A, is audio-relayed to Agent B, and Agent B mirrors the response to Subject A.

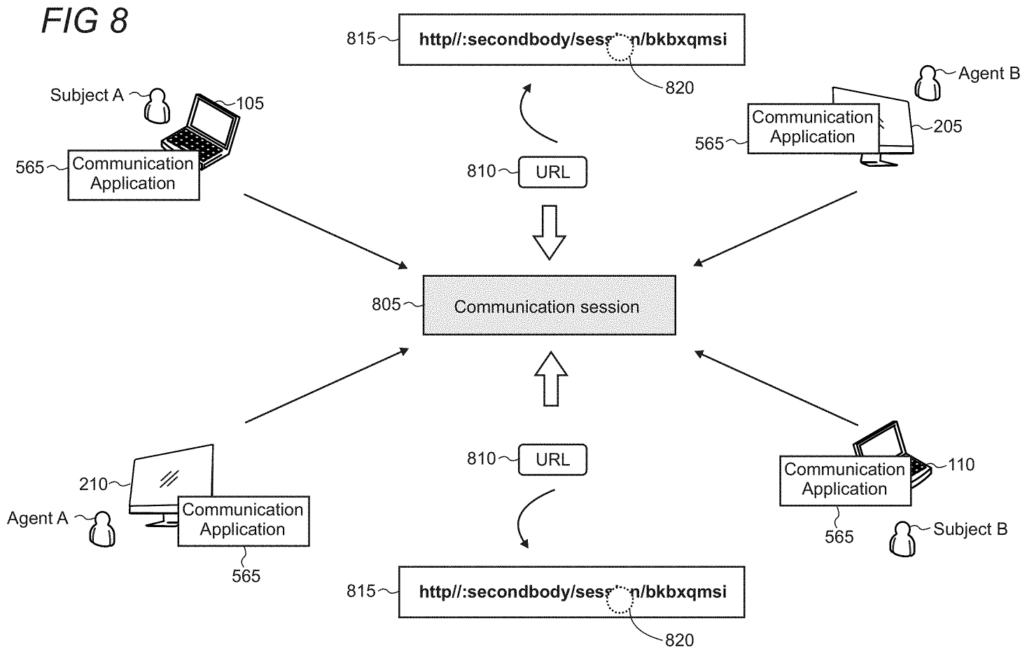

FIG. 8 shows an illustrative environment in which each participant is invited to and joins a communication session 805 using a link, such as a URL (uniform resource locator) 810. The URL may be generated after a participant or third-party, such as an administrator or other interested party, creates a communication session and identifies the participants. For example, a user may decide to create a communication session with several participants. The user may identify the specific subjects and agents for the session during the creation process so that each user is properly identified upon joining the session.

The users may be identified at creation using an e-mail address, a phone number, or a previously set up account name (e.g., username and password) associated with each user. The users' credentials may be verified at start-up with some two-step authentication procedure. For example, upon entering the session, a user may be prompted to enter their e-mail address or phone number. The host service 505 (FIG. 5) may transmit a one-time verification code to the user's e-mail or phone number that the user inputs at a prompt within the session on their computing device. Each user may be identified within the session using some uniquely identifying information.

Upon verification, the host service detects and associates the user to their role within the session, such as a subject, agent, administrator, or spectator. A spectator may be a person who can listen to communications from one, multiple, or all participants. The spectator may be given the option, via the session's UI (user interface), to select from which participant's vantage point they would like to listen to the session. The session may likewise limit to which participants the spectator can listen.

During the creation process, the user may likewise select to use standardized parameters or customized parameters. Typically, the communication protocols executed during the session, such as that shown in FIG. 7, may be consistent for each session. Other parameters may include selecting whether or not to record the session, whether to make the session blind between certain participants (e.g., without audio, video, or both), the session's duration, when to officially start the session, among other parameters.

The configuration of a blind session may include subjects and agents being blind to each other or the subjects being blind to each other. In some implementations, the blind option may be directed to the subjects. When the blind option is switched off, the session enables one or both of audio or video between subjects during the inactive state, but then disables the audio and video during the active state. Thus, switching the blind option on disables the subjects' audio, video, or both during the inactive state and active state, but then the subjects may communicate (e.g., over audio, video, or both) with each other during the post-session state.

Once the user creates the communication session 805, a URL 810 may be automatically generated and exposed to the user, such as presented on their display or transmitted to them via e-mail or text message. The URL, such as link 815, may be automatically transmitted by the communication application 565 to each participant or exposed to the user to communicate the link 815 to each participant. The users can enter the communication session by clicking the link at the scheduled time, as representatively shown by input 820.

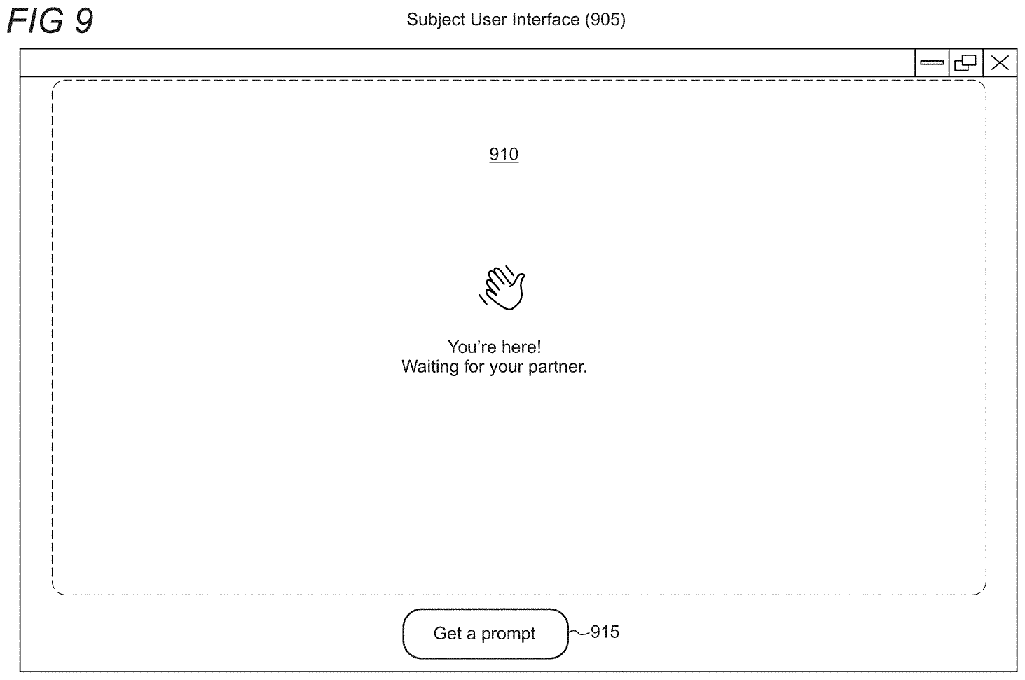

FIG. 9 shows an illustrative subject's user interface (UI) 905 displayed on computing device 105. Section 910 may be vacant until the subject's agent joins, with which the subject can have two-way A/V communications. The button “Get a prompt” 915 may be clicked on by the subject during an active state of the communication session to send an ice-breaker question or comment to the other subject. In this regard, the “Get a prompt” button may be an exception to the session's prohibition against communications between the subjects. This exception, however, includes questions and comments that are random to the initiator, in which case intentionally conveyed communications are still prohibited.

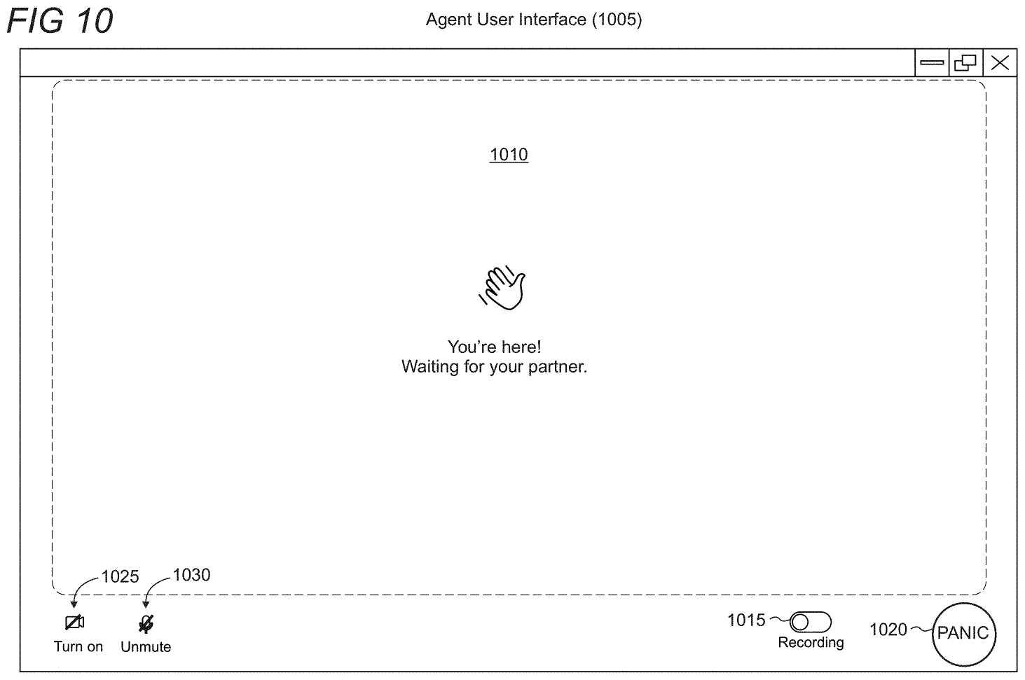

FIG. 10 shows an illustrative agent's UI 1005 that may be displayed on computing device 205. Section 1010 may be vacant until the agent's subject is present in the session and, in some implementations, until the session enters an active state. The agent may have other controls such as toggling of video 1025, muting 1030, and recording 1015. The agents may also have a “PANIC” button 1020 which, when clicked, can trigger an immediate pause to all communication transmissions by the subjects. The panic button may issue an alert to a remote administrator to enter the room and resolve any issues that may be occurring, such as if a subject becomes combative or inappropriate. An alert may be a prompt on an administrator's computing device, an e-mail, text message, etc.

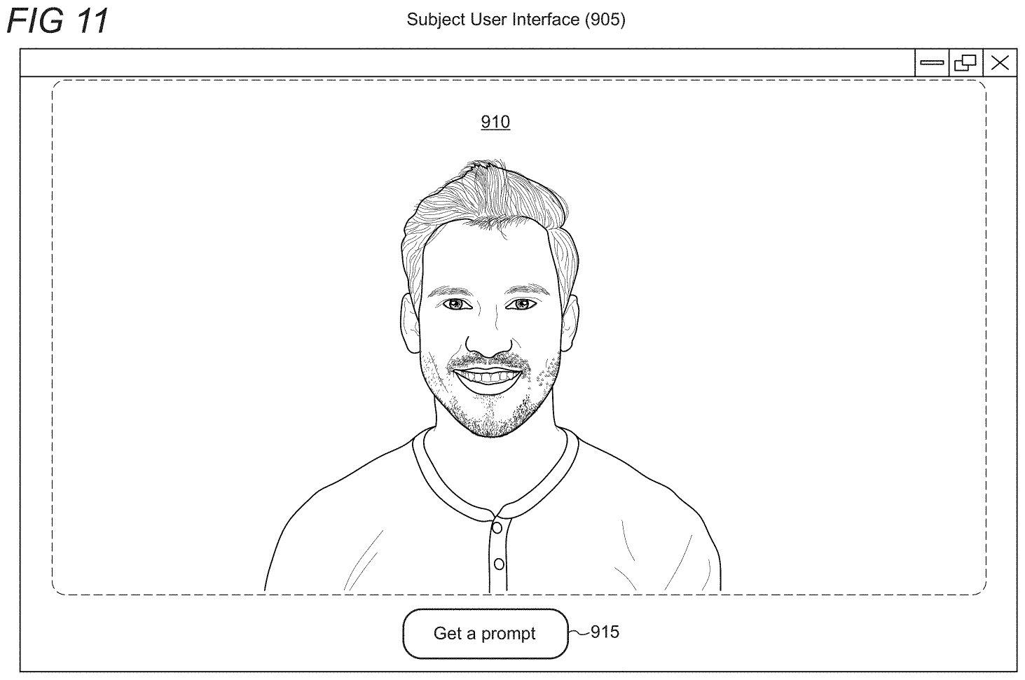

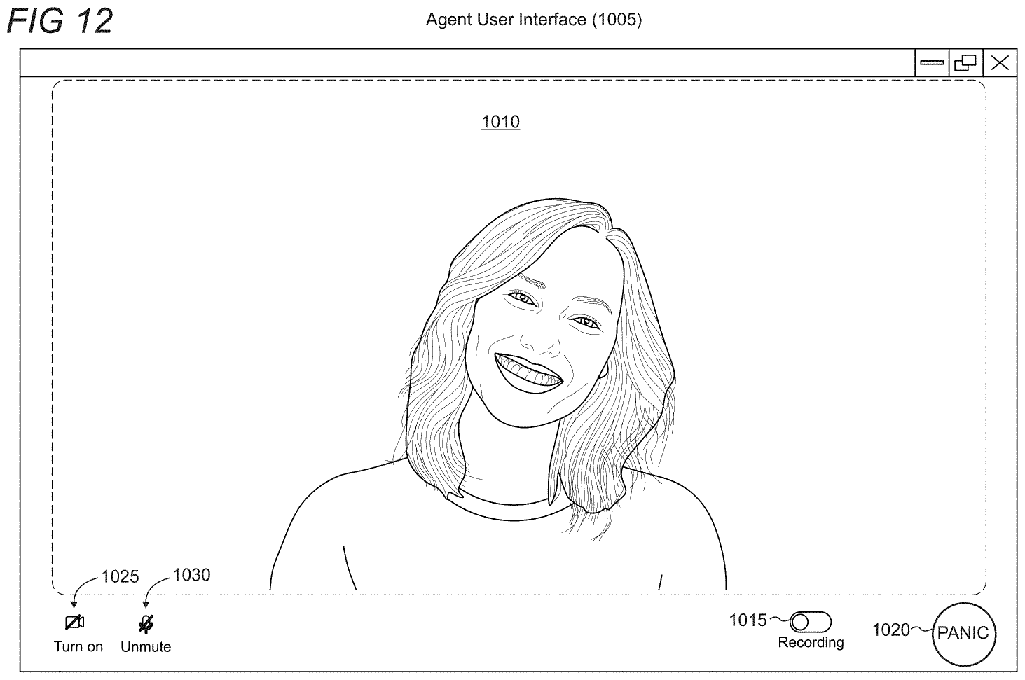

FIGS. 11 and 12 show illustrative representations of the subject's and agent's video sections 910, 1010 propagated with a respective participant upon the participant joining or the session becoming active. Although not shown, when all users join the session, the user interfaces associated with the subjects, agents, or both may display a selectable “Start Session” button that causes the session to start. For example, each subject and agent may select the start session button, each subject, each agent, or each participant, including spectators, may click the “Start Session” button to trigger the session's start.

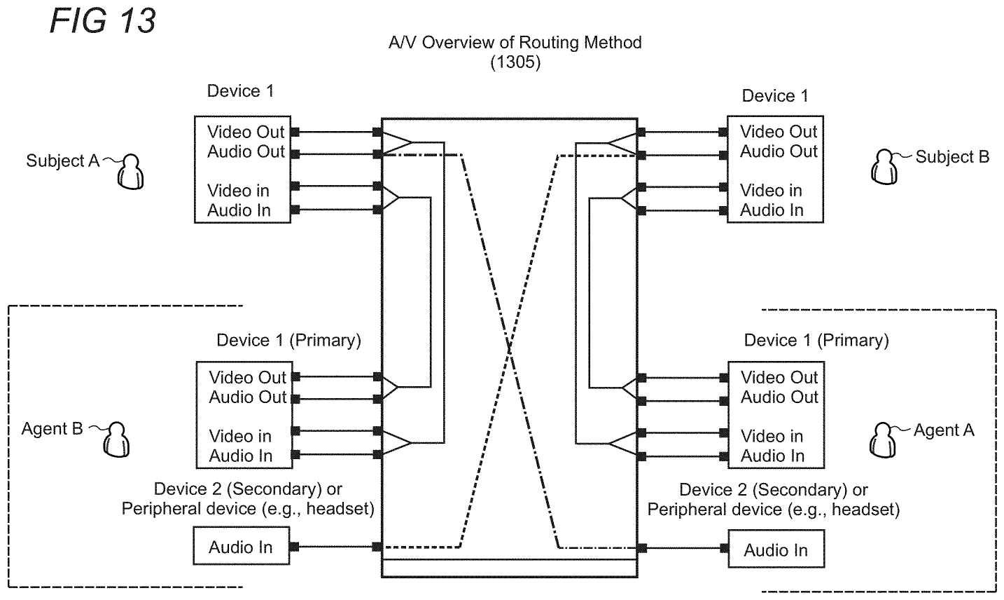

FIG. 13 shows an illustrative representation of the A/V routing method 1305 implemented locally on a respective user's computing device or remotely at the host service by the communication application 565. A/V communications between Subject A and Agent B are unfettered and permitted between their respective devices. Likewise, A/V communications between Subject B and Agent A are unfettered and permitted within the session by the application. While the application is configured to prevent any A/V transmissions with the other participants, the application permits the audio transmission from Subject A to Agent A and from Subject B to Agent B. Different line patterns are utilized for clarity in exposition.

The one-way audio-relay is received by the agent and relayed to the other subject, as discussed above. Depending on the implementation, the agents may utilize a second computing device to receive these relayed communications. For example, an agent may receive the audio-relay at a smartphone and then speak the received comments to their subject using their first, or primary, device. The agent may keep a single earbud in one ear for the secondary device's audio-relay and use another earbud for their primary device's primary communication channel with their dedicated subject.

While two devices are shown in FIG. 13, in some implementations, the application may be configured to allow two different outputs into two distinct peripheral devices using a single computing device. For example, the user may utilize one Bluetooth® earbud and one 3.5 mm jack audio cable. The application can detect and identify the distinct peripherals and transmit the communications accordingly without mixing signals. Alternatively, the user may utilize two of the same type connections with their headphones or speaker, and select, within the communication application 565, to which peripheral to direct the audio transmissions. For example, the user can associate one peripheral to one subject and the other peripheral to another subject.

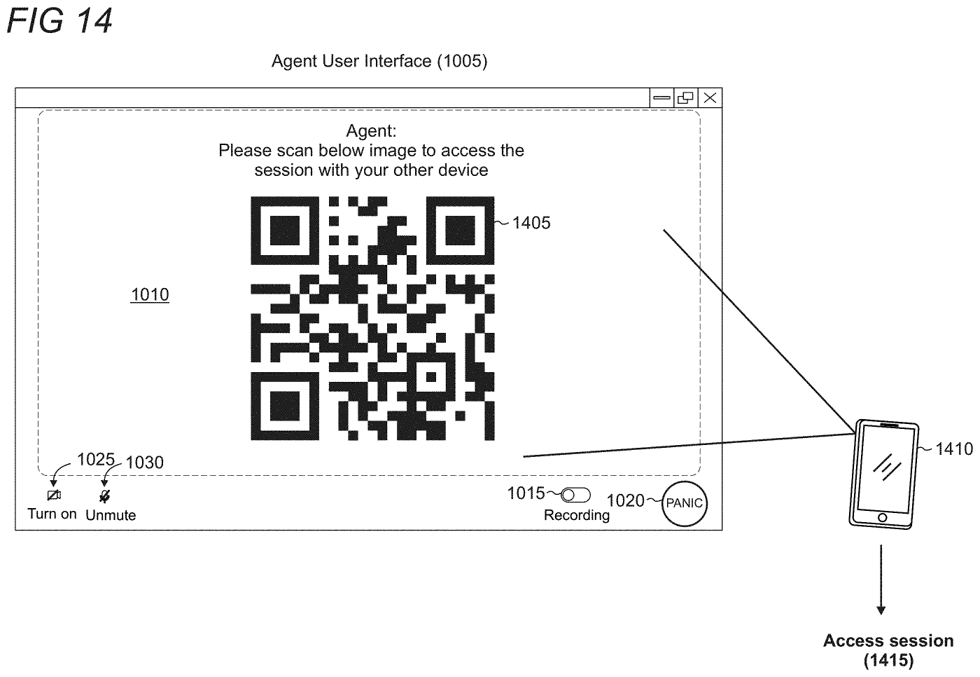

FIG. 14 shows an illustrative agent UI 1010 within the communication application 565, in which a QR (Quick Response) code 1405 is presented to the user within section 1010 of their primary computing device. Using their secondary computing device 1410, the agent can scan the QR code, enabling the user's smartphone to access the communication session, as shown by numeral 1415. The QR code is linked to the specific session in which the agent is present. The application recognizes the user's secondary device upon scanning the QR code and uses it to transmit the audio-relay transmissions. In some implementations, the agent may select which device to use as their primary and secondary computing devices upon having two devices joined into the session.

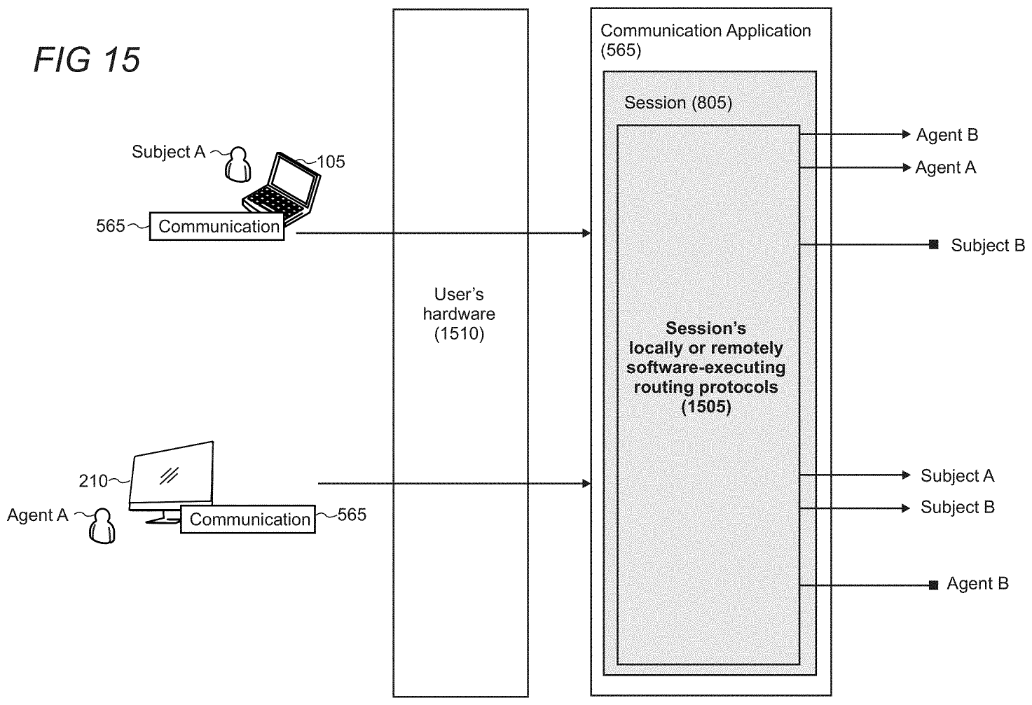

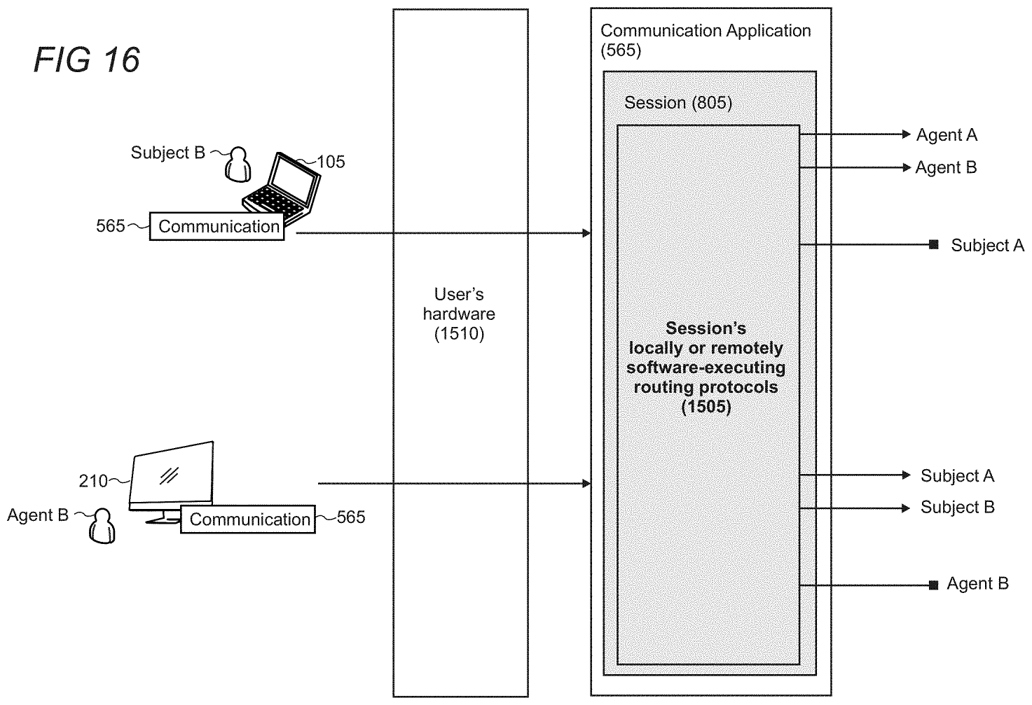

FIGS. 15 and 16 show illustrative environments in which the communication application 565 regulates transmissions among the participants. Typically, each participant's hardware 1510 can forward input video or audio to the communication application. The hardware can include a microphone, webcam, headset, and the like. Upon passing through the user's hardware, the session's local- or remotely-executing routing protocols 1505 may take control of the input transmissions and forward or inhibit them accordingly. The arrows indicate the forwarding of communications, and the squares represent the session prohibiting receipt of communications from that participant.

The communication application 565, for that particular session 805, may prevent audio or video transmissions from traveling to certain participants while forwarding audio or video communications to appropriate participants. The application's regulations are session-specific so that a user's permissions to receive communications in one session may change in a subsequent session, such as if the user switches from an agent to a subject.

The communication application may control routing based on the identified user at login using either the user's e-mail, phone number, account name, etc. The user accounts may be associated with a specific IP (Internet Protocol) address used by the communication application for routing. Routing techniques implemented by, for example, TCP/IP (Transmission Control Protocol/Internet Protocol), UDP (User Datagram Protocol), SIP (Session Initiation Protocol), among other protocols, may be used by the applications and devices. The communication application may operate at the application layer (FIG. 5) and then utilize a given network protocol stack for routing the forwarded transmissions to another user device.

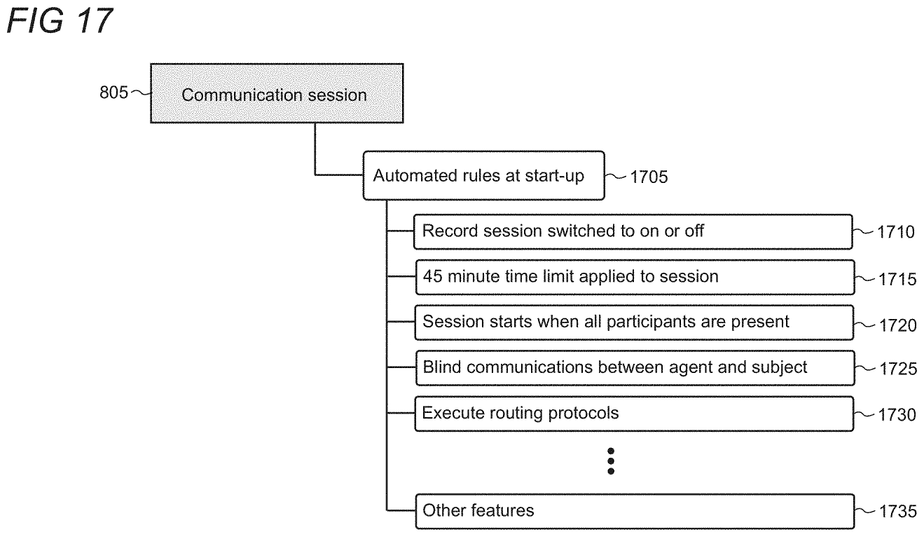

FIG. 17 shows an illustrative schema of automated rules that may be performed at start-up 1705 of a given communication session 805. Specific rules may be standardized for all communication sessions or may be customized by the user who creates a session. The automated start-up rules can include record session switched to on or off 1710, place a 45-minute time limit on the session 1715, session starts when all participants are present 1720, blind communications between agents and subjects 1725, execute routing protocols 1730, among other parameters and features 1730.

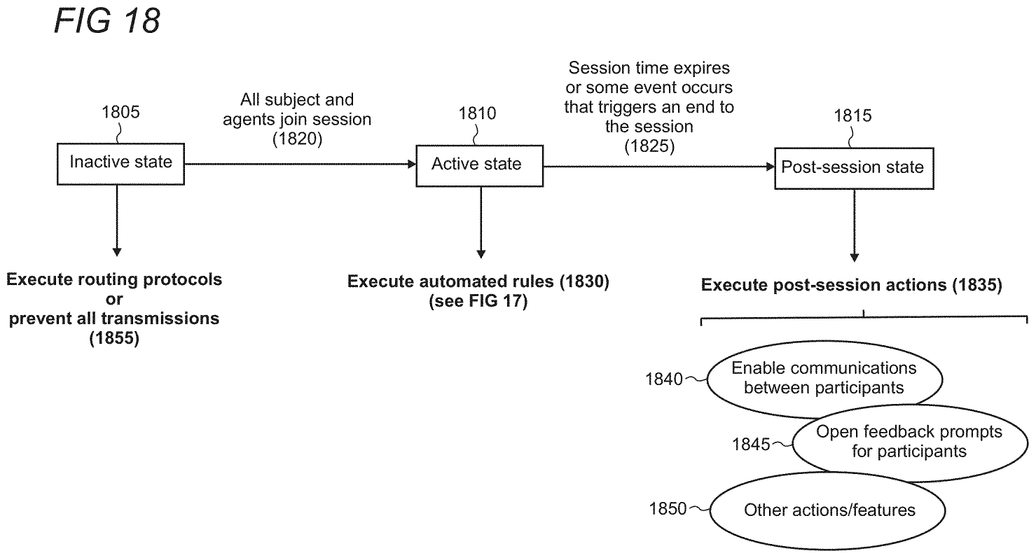

FIG. 18 shows an illustrative diagram in which a created communication session 805 can enter various states throughout its existence. For example, upon creation and before all participants join the session, the session may enter an inactive state 1805. During the inactive state, the communication session may execute and put in place the routing protocols to ensure subjects do not inadvertently communicate before the session begins. Alternatively, the communication application 565 may prevent all transmissions among participants during the inactive state 1855.

The communication session 805 may enter an active state 1810 upon all subjects and agents joining the session 1820. One or more of the remote communication application or the local applications may execute the automated rules 1830 (FIG. 17). The routing protocols may be implemented or maintained at the active state depending on whether they were initiated during the inactive state.

The active state may transition into a post-session state 1815 upon expiry of the session's pre-set time or some other event that triggers an end to session 1825. The communication application may execute one or more post-session actions 1835 at the commencement of the post-session state, such as enable communications between participants 1840 (including subjects), open feedback prompts for the participants (e.g., subjects, agents, spectators, administrators) 1845, or other actions/features 1850. For example, the communication application may disregard the previous routing protocols and allow completely open communications or initiate a new routing protocol. For example, a new routing protocol can include permitting A/V transmissions between subjects while restricting agents to only inbound and outbound audio transmissions. Other routing protocol configurations are also possible.

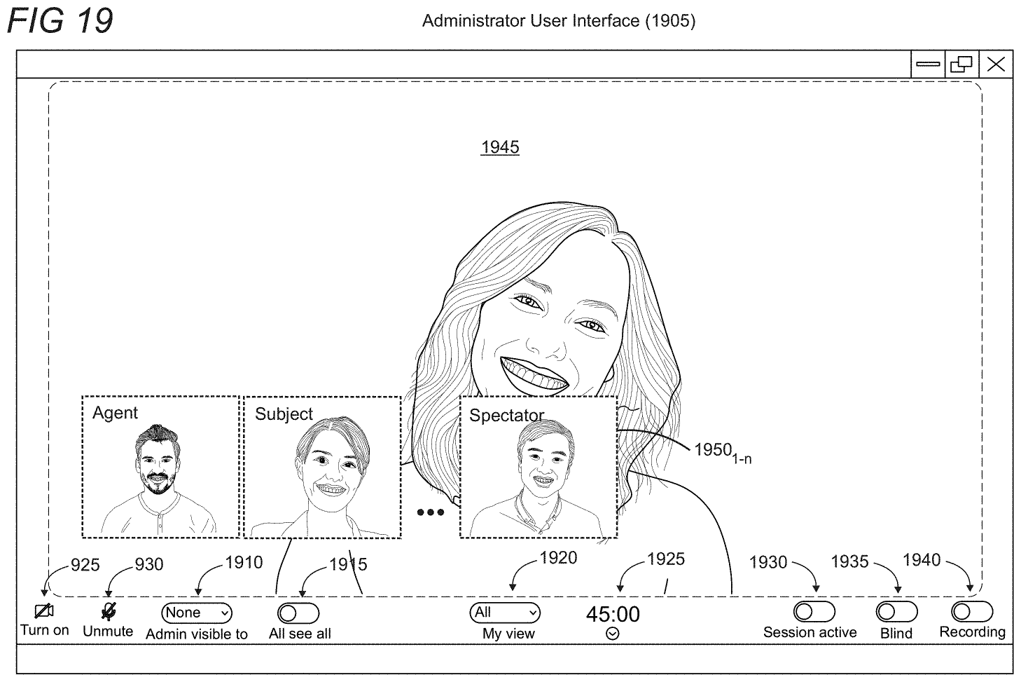

FIG. 19 shows an illustrative administrator UI 1905 in which an administrator can have various controls over the communication session 805. The administrator is an optional feature that may or may not be implemented. The administrator can create the session for the participants and control which parameters and protocols are implemented, or the automated rules can be executed. While other participants in the session can have their transmissions and UIs regulated, the administrator can have unfettered access and control over the session and transmissions.

Various control options along the bottom of the UI 1905 are depicted, which include who the administrator may be visible to 1910, who the participants can see 1915, the administrator's view 1920, the time limit 1925, whether the session is active 1930, whether the session is blind between agents and subjects 1935, and whether the session is recorded 1940. The UI's section 1945 may be where a given participant's video is shown. And boxes 1950 may be panned across the UI so the administrator can see each video-enabled participant, including agents, subjects, and spectators.

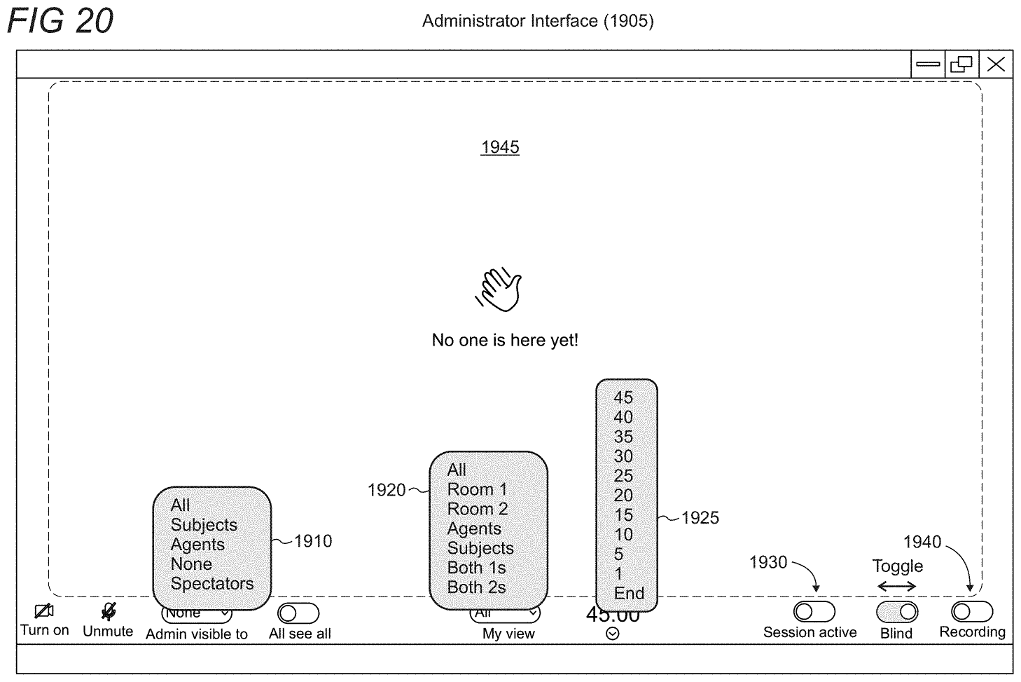

FIG. 20 shows the illustrative administrator UI 1905 in which selectable options for the various parameters are displayed for user-selection. As shown, the user can select a duration for a session, which participant to view, and who can view the administrator. Regarding the “My view” 1920 options, the administrator can view certain rooms comprised of a given Subject-Agent. A Room may include, for example, Subject A and Agent B, or Subject B and Agent A. The “Both 1s” and “Both 2s” reference Subject A with Agent A and Subject B with Agent B. The administrator can alternatively view agents only or subjects only.

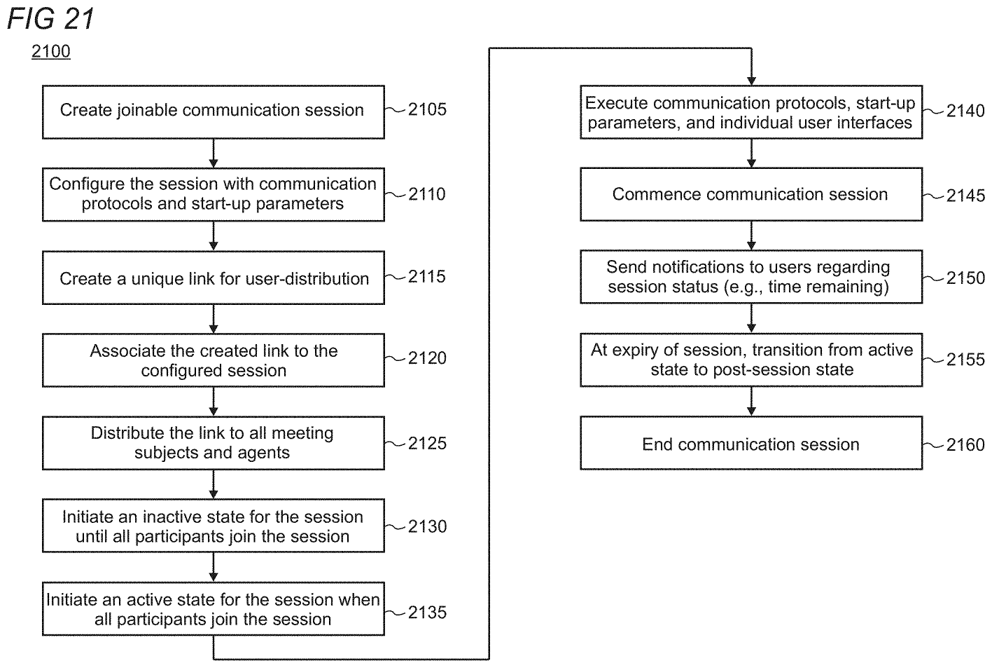

FIGS. 21-24 show illustrative methods in flowchart-form, which may be performed by one or more communication applications instantiated on participant computing devices, instantiated on the remote host service, or a combination thereof. The actions may be performed on multiple devices, by a single device, or by the host service which affects the session for all participants. The method's steps are exemplary and other variations of the steps are also possible. Furthermore, discussion of a “device” performing a step can include one or more participant devices, each device, or the remote host service.

In step 2105, a user, such as a participant, may use a computing device to create a communication session. In step 2110, the device may configure the session with communication protocols and start-up parameters. In step 2115, the device may create a unique link for user-distribution. In step 2120, the device may associate the created link to the configured session. In step 2125, the device may distribute the link to all meeting subjects and agents. For example, the communication application may automatically transmit via e-mail or text message the link to participants, or the application may expose the URL to the user for distribution.

In step 2130, the device may initiate an inactive state for the session until all participants join the session. During the inactive state, all communication transmissions may be prohibited by the session, or the routing protocols may be implemented to ensure subjects cannot interact before the session. In some scenarios, however, the inactive state can be configured to enable complete and unfettered transmissions among the participants, including the subjects. Alternatively, the subjects and agents can communicate with each other so that the agents can explain the process and what to expect during the session.

In step 2135, the device may initiate an active state for the session when all participants have joined. In step 2140, the device may execute communication routing protocols, start-up parameters, and individual user interfaces (UIs). The start-up parameters may be standardized or based on the customized parameters input by the session's creator. In step 2145, the device commences the communication session. In step 2150, the device sends notifications to users regarding session status (e.g., time remaining). In step 2155, at the expiry of the session's time, the device transitions from the active state to the post-session state. The post-session state may alternatively occur after the occurrence of some other event, such as one or more agents electing to end the session. In step 2160, the device ends the communication session.

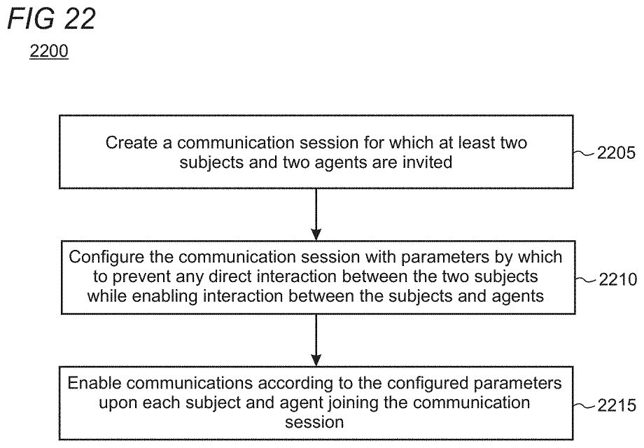

In step 2205, in FIG. 22, a computing device creates a communication session for which at least two subjects and two agents are invited. In step 2210, the computing device configures the communication session with parameters by which to prevent any direct interaction between the two subjects while enabling interaction between the subjects and agents. In step 2215, the computing device enables communications according to the configured parameters upon each subject and agent joining the communication session.

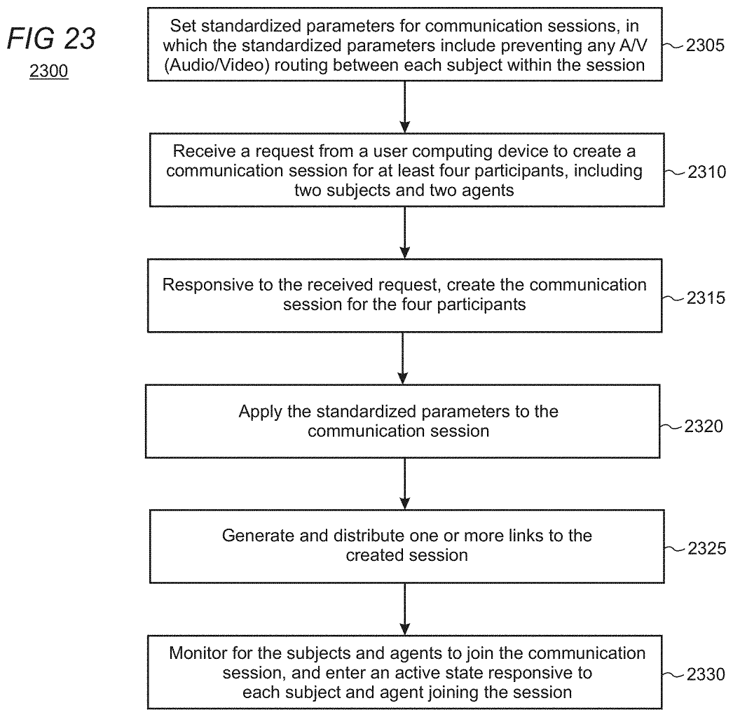

In step 2305, in FIG. 23, a remote host service sets standardized parameters for communication sessions, in which the standardized parameters include preventing any A/V (Audio/Video) routing between each subject within the session. In step 2310, the host service receives a request from a user computing device to create a communication session for at least four participants, including two subjects and two agents. In step 2315, the host service, responsive to the received request, creates the communication session for the four participants. In step 2320, the host service applies the standardized parameters to the communication session. In step 2325, the host service generates one or more links to the created session and distributes the links to the participants. In step 2330, the host service monitors for the subjects and agents to join the communication session and then enters an active state upon detecting each subject and agent has joined the session.

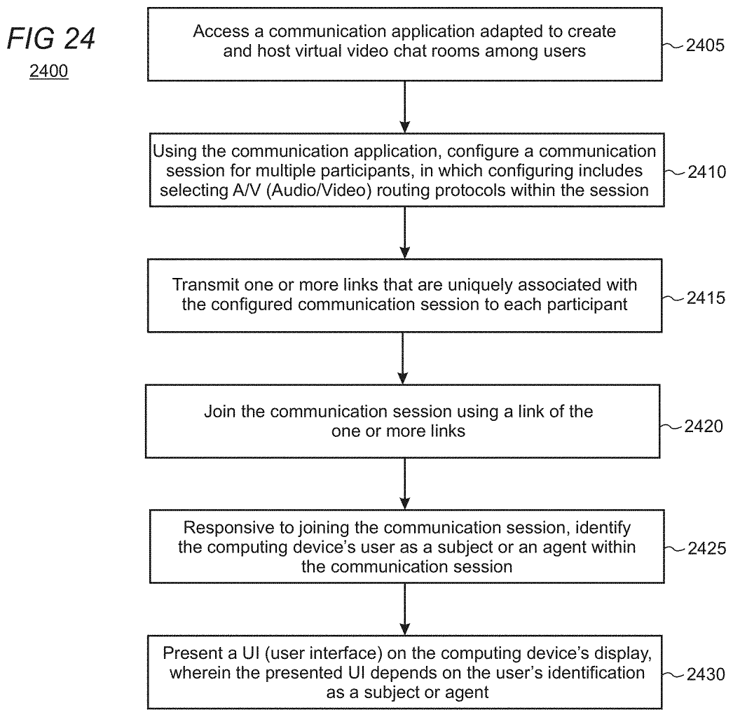

In step 2405, in FIG. 24, a computing device accesses a communication application adapted to create and host virtual video chat rooms among users. In step 2410, the computing device, using the communication application, configures a communication session for multiple participants, in which configuring includes selecting A/V (Audio/Video) routing protocols within the session. In step 2415, the computing device transmits one or more links uniquely associated with the configured communication session to each participant. In step 2420, the computing device joins the communication session using a link of the one or more links. In step 2425, the communication application, responsive to the user joining the communication session on the computing device, identifies the computing device's user as a subject or an agent within the communication session. In step 2430, the computing device presents a UI (user interface) on the display, in which the presented display depends on the user's identification as a subject or agent.

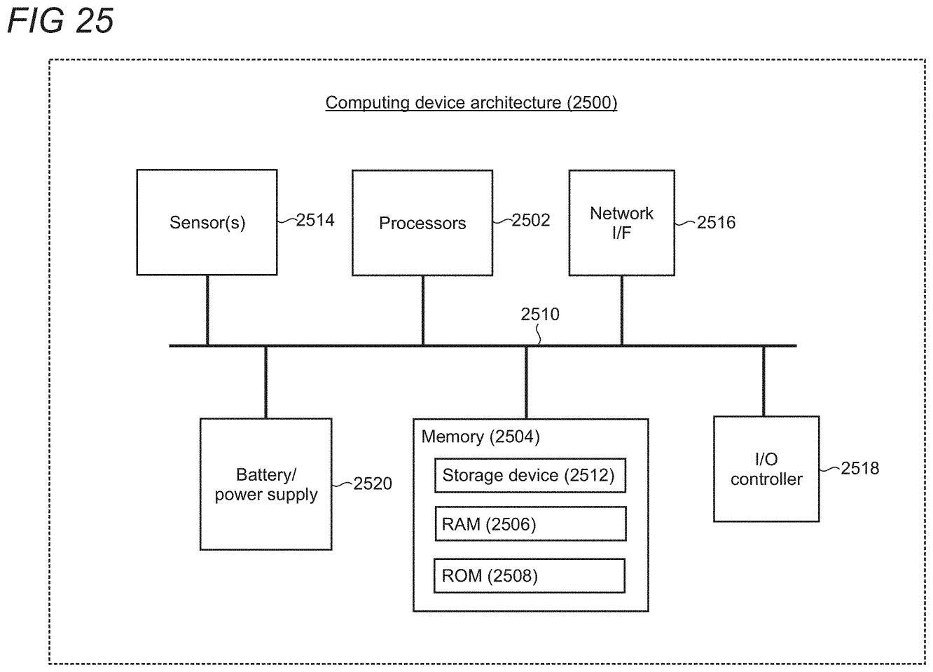

FIG. 25 shows an illustrative architecture 2500 for a device, such as a smartphone, tablet, laptop computer, or access device, capable of executing the various features described herein. The architecture 2500 illustrated in FIG. 25 includes one or more processors 2502 (e.g., central processing unit, dedicated AI chip, graphics processing unit, etc.), a system memory 2504, including RAM (random access memory) 2506, ROM (read-only memory) 2508, and long-term storage devices 2512. The system bus 2510 operatively and functionally couples the components in the architecture 2500. A basic input/output system containing the basic routines that help to transfer information between elements within the architecture 2500, such as during start-up, is typically stored in the ROM 2508. The architecture 2500 further includes a long-term storage device 2512 for storing software code or other computer-executed code that is utilized to implement applications, the file system, and the operating system. The storage device 2512 is connected to processor 2502 through a storage controller (not shown) connected to bus 2510. The storage device 2512 and its associated computer-readable storage media provide non-volatile storage for the architecture 2500. Although the description of computer-readable storage media contained herein refers to a long-term storage device, such as a hard disk or CD-ROM drive, it may be appreciated by those skilled in the art that computer-readable storage media can be any available storage media that can be accessed by the architecture 2500, including solid-state drives and flash memory.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 2500.

According to various embodiments, the architecture 2500 may operate in a networked environment using logical connections to remote computers through a network. The architecture 2500 may connect to the network through a network interface unit 2516 connected to the bus 2510. It may be appreciated that the network interface unit 2516 also may be utilized to connect to other types of networks and remote computer systems. The architecture 2500 also may include an input/output controller 2518 for receiving and processing input from a number of other devices, including a keyboard, mouse, touchpad, touchscreen, control devices such as buttons and switches or electronic stylus (not shown in FIG. 25). Similarly, the input/output controller 2518 may provide output to a display screen, user interface, a printer, or other type of output device (also not shown in FIG. 25).

It may be appreciated that any software components described herein may, when loaded into the processor 2502 and executed, transform the processor 2502 and the overall architecture 2500 from a general-purpose computing system into a special-purpose computing system customized to facilitate the functionality presented herein. The processor 2502 may be constructed from any number of transistors or other discrete circuit elements, which may individually or collectively assume any number of states. More specifically, the processor 2502 may operate as a finite-state machine, in response to executable instructions contained within the software modules disclosed herein. These computer-executable instructions may transform the processor 2502 by specifying how the processor 2502 transitions between states, thereby transforming the transistors or other discrete hardware elements constituting the processor 2502.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in architecture 2500 in order to store and execute the software components presented herein. It also may be appreciated that the architecture 2500 may include other types of computing devices, including wearable devices, handheld computers, embedded computer systems, smartphones, PDAs, and other types of computing devices known to those skilled in the art. It is also contemplated that the architecture 2500 may not include all of the components shown in FIG. 25, may include other components that are not explicitly shown in FIG. 25, or may utilize an architecture completely different from that shown in FIG. 25.

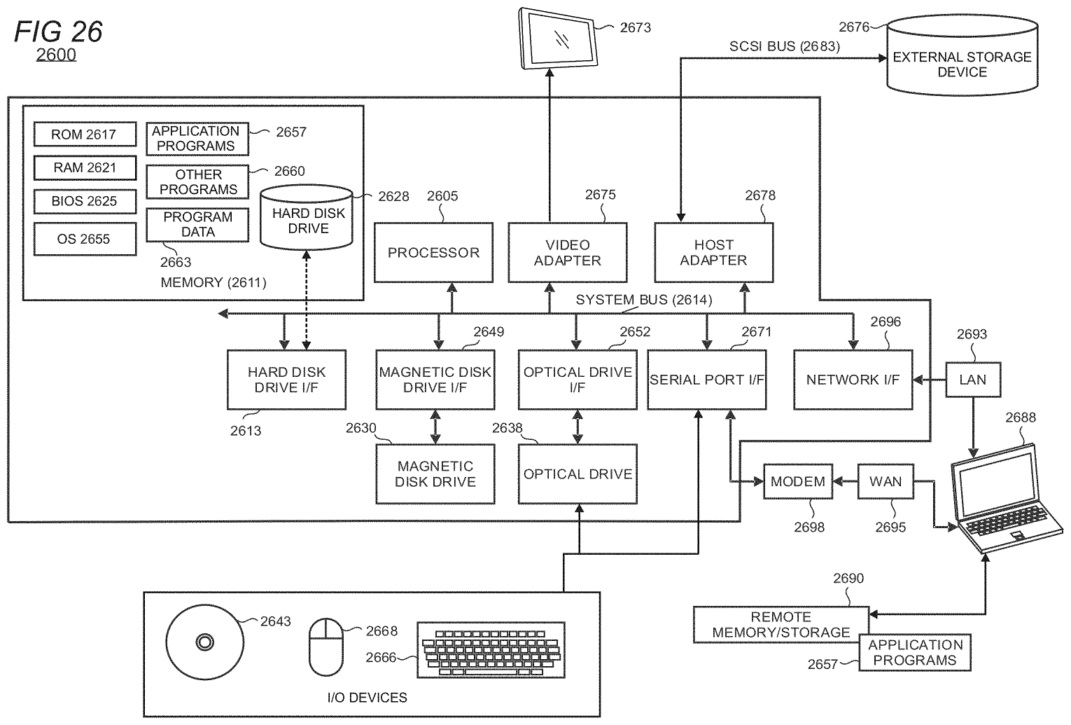

FIG. 26 is a simplified block diagram of an illustrative computer system 2600 such as a remote server, smartphone, tablet computer, laptop computer, or personal computer (PC) which the present disclosure may be implemented. Computer system 2600 includes a processor 2605, a system memory 2611, and a system bus 2614 that couples various system components, including the system memory 2611 to the processor 2605. The system bus 2614 may be any of several types of bus structures, including a memory bus or memory controller, a peripheral bus, or a local bus using any of a variety of bus architectures. The system memory 2611 includes read-only memory (ROM) 2617 and random access memory (RAM) 2621. A basic input/output system (BIOS) 2625, containing the basic routines that help to transfer information between elements within the computer system 2600, such as during start-up, is stored in ROM 2617. The computer system 2600 may further include a hard disk drive 2628 for reading from and writing to an internally disposed hard disk, a magnetic disk drive 2630 for reading from or writing to a removable magnetic disk (e.g., a floppy disk), and an optical disk drive 2638 for reading from or writing to a removable optical disk 2643 such as a CD (compact disc), DVD (digital versatile disc), or other optical media. The hard disk drive 2628, magnetic disk drive 2630, and optical disk drive 2638 are connected to the system bus 2614 by a hard disk drive interface 2646, a magnetic disk drive interface 2649, and an optical drive interface 2652, respectively. The drives and their associated computer-readable storage media provide non-volatile storage of computer-readable instructions, data structures, program modules, and other data for the computer system 2600. Although this illustrative example includes a hard disk, a removable magnetic disk 2633, and a removable optical disk 2643, other types of computer-readable storage media which can store data that is accessible by a computer such as magnetic cassettes, Flash memory cards, digital video disks, data cartridges, random access memories (RAMs), read-only memories (ROMs), and the like may also be used in some applications of the present disclosure. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, are intended to cover non-transitory embodiments, and does not include waves, signals, and/or other transitory and/or intangible communication media.

A number of program modules may be stored on the hard disk, magnetic disk, optical disk 2643, ROM 2617, or RAM 2621, including an operating system 2655, one or more application programs 2657, other program modules 2660, and program data 2663. A user may enter commands and information into the computer system 2600 through input devices such as a keyboard 2666, pointing device (e.g., mouse) 2668, or touchscreen display 2673. Other input devices may include a microphone, joystick, game pad, satellite dish, scanner, trackball, touchpad, touch-sensitive device, voice-command module or device, user motion or user gesture capture device, or the like. These and other input devices are often connected to the processor 2605 through a serial port interface 2671 that is coupled to the system bus 2614, but may be connected by other interfaces, such as a parallel port, game port, or universal serial bus (USB). A monitor 2673 or other type of display device is also connected to the system bus 2614 via an interface, such as a video adapter 2675. In addition to the monitor 2673, personal computers typically include other peripheral output devices (not shown), such as speakers and printers. The illustrative example shown in FIG. 26 also includes a host adapter 2678, a Small Computer System Interface (SCSI) bus 2683, and an external storage device 2676 connected to the SCSI bus 2683.

The computer system 2600 is operable in a networked environment using logical connections to one or more remote computers, such as a remote computer 2688. The remote computer 2688 may be selected as another personal computer, a server, a router, a network PC, a peer device, or other common network node, and typically includes many or all of the elements described above relative to the computer system 2600, although only a single representative remote memory/storage device 2690 is shown in FIG. 26. The logical connections depicted in FIG. 26 include a local area network (LAN) 2693 and a wide area network (WAN) 2695. Such networking environments are often deployed, for example, in offices, enterprise-wide computer networks, intranets, and the Internet.

When used in a LAN networking environment, the computer system 2600 is connected to the local area network 2693 through a network interface or adapter 2696. When used in a WAN networking environment, the computer system 2600 typically includes a broadband modem 2698, network gateway, or other means for establishing communications over the wide area network 2695, such as the Internet. The broadband modem 2698, which may be internal or external, is connected to the system bus 2614 via a serial port interface 2671. In a networked environment, program modules related to the computer system 2600, or portions thereof, may be stored in the remote memory storage device 2690. It is noted that the network connections shown in FIG. 26 are illustrative and other means of establishing a communications link between the computers may be used depending on the specific requirements of an application of the present disclosure.

Various embodiments are discussed herein to implement the agent-based communications. One exemplary embodiment includes a computing device, comprising: a network interface; input/output mechanisms including a camera, display, and microphone; one or more processors; and one or more hardware-based memory devices storing a communication application or plugin adapted to create virtual communication sessions between subjects, the memory devices further having instructions which, when executed by the one or more processors, cause the computing device to: create a communication session for which at least two subjects and two agents are invited; configure the communication session with parameters by which to prevent any direct interaction between the two subjects while enabling interaction between the subjects and agents; and enable communications according to the configured parameters upon each subject and agent joining the communication session.

As another example, the communication application is supported on a remote service which a user accesses using a browser instantiated on the computing device. As another example, the communication application or plugin is instantiated on the computing device and interoperates with a remotely hosted communication application that performs some functionality. In a further example, each subject and each agent are remote to each other and operate their own respective computing devices. In another example, preventing any interaction between the two subjects includes prohibiting audio or video data transmission between the two. As another example, the subjects include Subject A and Subject B, and the agents include Agent A and Agent B, and wherein the communication session's parameters enable Subject A to exchange audio and video signals with Agent B. As a further example, the communication session's parameters enable Subject A to transmit one-way audio signals to Agent A, but prevents all other audio and video exchanges between Subject A and Agent A. In another example, the communication session's parameters enable Subject B to exchange audio and video signals with Agent A, and the parameters enable Subject B to transmit one-way audio signals to Agent B, but prevents all other audio and video exchanges between Subject B and Agent B. In another example, upon creation of the communication session, the communication session enters an inactive state by which it is configured to periodically monitor for each subject and each agent to join the communication session, and upon detecting that each subject and agent has joined, the communication session enters an active state by which it executes the configured parameters. As another example, at expiry of the communication session after some pre-set event occurs, the communication session enters a post-active state by which the communication application prompts a request for information to a user of the computing device. In another example, the pre-set event includes any one or more of expiration of time or a participant leaves the communication session.

Another embodiment includes a method performed by a remote host service to utilize agents as proxies for virtual communications between subjects, comprising: setting standardized parameters for communication sessions, in which the standardized parameters include preventing any A/V (Audio/Video) routing between each subject within the communication session during an active state for communication sessions; receiving a request from a user computing device to create a communication session for at least four participants, including two subjects and two agents; responsive to the request, creating the communication session for the four participants; applying the standardized parameters to the communication session; generating one or more links to the created communication session; distributing the one or more links to at least the user computing device; monitoring for the subjects and agents to join the communication session; and entering an active state responsive to detecting each subject and agent has joined the communication session, wherein entering the active state triggers initiation of the standardized parameters.

As another example, the host service modifies the standardized parameters according to any modifications in the received request. In a further example, the communication session permits the subjects to interact during a post-session state of the communication session, which occurs after expiry of the active state. In another example, the standardized parameters are configured to allow each subject to exchange A/V communications with a single and distinct agent. As another example, the created communication session is configured to identify which participant is a subject or agent by the participant's association with a unique account set up with the host service or other unique credential for the participants.

Another exemplary embodiment includes one or more hardware-based non-transitory computer-readable memory devices stored within a computing device, the memory devices including instructions which, when executed by one or more processors, cause the computing device to: access a communication application adapted to create and host virtual video chat rooms among users; using the communication application, configure a communication session for multiple participants, in which the participants include at least two subjects and two agents, and the configuring includes selecting A/V (Audio/Video) routing protocols when the communication session begins; transmit one or more links that are uniquely associated with the configured communication session to each participant; join the communication session using a link of the one or more links; responsive to joining the communication session, identify the computing device's user as a subject or an agent within the communication session; and presenting a UI (user interface) on the computing device's display, wherein the presented UI depends on the user's identification as a subject or agent.

In another example, the identification of the user as a subject or agent also affects the A/V routing protocols applied to the user during the communication session. As another example, responsive to the user being identified as an agent, the user's communication session will allow one-way receipt of audio signals from one of the subjects. As a further example, responsive to the user being identified as a subject, the user's communication session will allow one-way transmission of audio signals to one of the agents.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computing device, comprising:
a network interface;
input/output mechanisms including a camera, display, and microphone;
one or more processors; and
one or more hardware-based memory devices storing a communication application or plugin adapted to create virtual communication sessions between subjects, the memory devices further having instructions which, when executed by the one or more processors, cause the computing device to:
create a communication session for which at least two subjects and two agents are invited;
configure the communication session with parameters by which to prevent any direct interaction between the two subjects while enabling interaction between the subjects and agents; and
enable communications according to the configured parameters upon each subject and agent joining the communication session.

2. The computing device of claim 1, wherein the communication application is supported on a remote service which a user accesses using a browser instantiated on the computing device.

3. The computing device of claim 1, wherein the communication application or plugin is instantiated on the computing device and interoperates with a remotely hosted communication application that performs some functionality.

4. The computing device of claim 1, wherein each subject and each agent are remote to each other and operate their own respective computing devices.

5. The computing device of claim 1, wherein preventing any interaction between the two subjects includes prohibiting audio or video data transmission between the two.

6. The computing device of claim 5, wherein the subjects include Subject A and Subject B, and the agents include Agent A and Agent B, and wherein the communication session's parameters enable Subject A to exchange audio and video signals with Agent B.

7. The computing device of claim 6, wherein the communication session's parameters enable Subject A to transmit one-way audio signals to Agent A, but prevents all other audio and video exchanges between Subject A and Agent A.

8. The computing device of claim 7, wherein the communication session's parameters enable Subject B to exchange audio and video signals with Agent A, and the parameters enable Subject B to transmit one-way audio signals to Agent B, but prevents all other audio and video exchanges between Subject B and Agent B.

9. The computing device of claim 1, wherein, upon creation of the communication session, the communication session enters an inactive state by which it is configured to periodically monitor for each subject and each agent to join the communication session, and upon detecting that each subject and agent has joined, the communication session enters an active state by which it executes the configured parameters.

10. The computing device of claim 9, wherein at expiry of the communication session after some pre-set event occurs, the communication session enters a post-active state by which the communication application prompts a request for information to a user of the computing device.

11. The computing device of claim 10, wherein the pre-set event includes any one or more of expiration of time or a participant leaves the communication session.

12. A method performed by a remote host service to utilize agents as proxies for virtual communications between subjects, comprising:
setting standardized parameters for communication sessions, in which the standardized parameters include preventing any A/V (Audio/Video) routing between each subject within the communication session during an active state for communication sessions;
receiving a request from a user computing device to create a communication session for at least four participants, including two subjects and two agents;
responsive to the request, creating the communication session for the four participants;
applying the standardized parameters to the communication session;
generating one or more links to the created communication session;
distributing the one or more links to at least the user computing device;
monitoring for the subjects and agents to join the communication session; and
entering an active state responsive to detecting each subject and agent has joined the communication session, wherein entering the active state triggers initiation of the standardized parameters.

13. The method of claim 12, wherein the host service modifies the standardized parameters according to any modifications in the received request.

14. The method of claim 12, wherein the communication session permits the subjects to interact during a post-session state of the communication session, which occurs after expiry of the active state.

15. The method of claim 12, wherein the standardized parameters are configured to allow each subject to exchange A/V communications with a single and distinct agent.

16. The method of claim 12, wherein the created communication session is configured to identify which participant is a subject or agent by the participant's association with a unique account set up with the host service or other unique credential for the participants.

17. One or more hardware-based non-transitory computer-readable memory devices stored within a computing device, the memory devices including instructions which, when executed by one or more processors, cause the computing device to:
access a communication application adapted to create and host virtual video chat rooms among users;
using the communication application, configure a communication session for multiple participants, in which the participants include at least two subjects and two agents, and the configuring includes selecting A/V (Audio/Video) routing protocols when the communication session begins;
transmit one or more links that are uniquely associated with the configured communication session to each participant;
join the communication session using a link of the one or more links;
responsive to joining the communication session, identify the computing device's user as a subject or an agent within the communication session; and
presenting a UI (user interface) on the computing device's display, wherein the presented UI depends on the user's identification as a subject or agent.

18. The one or more hardware-based non-transitory computer-readable memory devices of claim 17, wherein the identification of the user as a subject or agent also affects the A/V routing protocols applied to the user during the communication session.

19. The one or more hardware-based non-transitory computer-readable memory devices of claim 18, wherein, responsive to the user being identified as an agent, the user's communication session will allow one-way receipt of audio signals from one of the subjects.

20. The one or more hardware-based non-transitory computer-readable memory devices of claim 18, wherein, responsive to the user being identified as a subject, the user's communication session will allow one-way transmission of audio signals to one of the agents.
